(19) United States
(12) Patent Application Publication
(10) Pub. No.: US 2015/0115144 A1
(43) Pub. Date: Apr. 30, 2015

(54) SCINTILLATOR AND PULSE SHAPE DISCRIMINATION FOR USE WITH THE SCINTILLATOR

(71) Applicant: Saint-Gobain Ceramics & Plastics, Inc., Worcester, MA (US)

(72) Inventors: Kan Yang, Solon, OH (US); Peter R. Menge, Novelty, OH (US); Julien Lejay, Rueil Malmaison (FR); Vladimir Ouspenski, Saint-Pierre les Nemours (FR)

(21) Appl. No.: 14/515,104

(22) Filed: Oct. 15, 2014

Related U.S. Application Data
(60) Provisional application No. 61/904,906, filed on Nov. 15, 2013.

(30) Foreign Application Priority Data
Oct. 25, 2013 (FR) 1360432

(51) Int. Cl. C01F 17/00; C09K 11/77; G01T 1/20; G01V 5/08; G01T 1/202

(52) U.S. Cl. CPC C01F 17/0056; G01V 5/08; G01T 1/2026; G01T 1/2006; C09K 11/7773
USPC 250/254; 250/361 R; 250/362; 250/259; 423/263

(57) ABSTRACT

In an embodiment, scintillator can have a Figure of Merit of 0.4 at a temperature greater than 120° C., a Figure of Merit of at least 0.05 at a temperature of at least 160° C., or both. In another embodiment, a scintillator can include a Br-containing or an I-containing elpasolite. Either scintillator can be used in a radiation detection apparatus that include a photosensor and a radiation detection apparatus. Such an apparatus can be used to detect and discriminate two different types of radiation over a wide range of temperatures. The radiation detection apparatus can be useful in drilling, well logging, or as a portal detector.

### CROSS-REFERENCE TO RELATED APPLICATIONS

The present application claims priority from French Patent Application No. 1360432, filed Oct. 25, 2013, entitled “SCINTILLATOR AND PULSE SHAPE DISCRIMINATION FOR USE WITH THE SCINTILLATOR”, naming as inventors Kan Yang et al., and U.S. Provisional Patent Application No. 61/904,906, filed Nov. 15, 2013, entitled “SCINTILLATOR AND PULSE SHAPE DISCRIMINATION FOR USE WITH THE SCINTILLATOR”, naming as inventors Kan Yang et al., which applications are incorporated by reference herein in their entireties.

### FIELD OF THE DISCLOSURE

The present disclosure is directed to analyzer devices and methods of using such analyzer devices.

### BACKGROUND

Scintillator-based detectors are used in a variety of applications, including research in nuclear physics, oil exploration, field spectroscopy, container and baggage scanning, and medical diagnostics. When a scintillator material of the scintillator-based detector is exposed to ionizing radiation, the scintillator material absorbs energy of incoming radiation and scintillates, remitting the absorbed energy in the form of photons. A photosensor of the scintillator-based detector detects the emitted photons. Radiation detection apparatuses can analyze pulses for many different reasons. Continued improvements are desired.

### BRIEF DESCRIPTION OF THE DRAWINGS

Embodiments are illustrated by way of example and are not limited in the accompanying figures.

FIG. 1 includes a depiction of a drilling apparatus.

FIG. 2 includes a depiction of a radiation detection apparatus within the drilling apparatus.

FIG. 3 includes plots of pulse shape discrimination parameter as a function of pulse height and counts.

FIG. 4 includes a block diagram illustrating a particular embodiment of the analyzer device within the radiation detection apparatus of FIG. 2.

FIG. 5 includes a flow chart of a process of using the analyzer device of FIG. 2.

FIG. 6 includes a plot of time versus intensity for neutrons and gamma radiation for a particular scintillator composition.

FIGS. 7 and 8 include plots at different temperatures for pulse shape discrimination parameter as a function of pulse height.

FIG. 9 includes plots of scintillation counts as a function of pulse shape discrimination parameter at different temperatures.

FIG. 10 includes a plot of temperature versus Figure of Merit for a particular scintillator composition at different temperatures.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the scintillation and radiation detection arts.

Scintillator compounds can be used as a dual mode neutron and gamma radiation detection apparatus over a wide range of temperatures including temperatures greater than 120° C. and even greater than 150° C. The radiation detection apparatus can be exposed temperatures from about −40° C. to 160° C., 200° C., or higher. Such compounds are useful for high temperature applications such as in drilling or well logging or wide temperatures ranges, such as those seen with portal detectors. In an embodiment, such compounds can be identified by applying a fast Fourier transform to a portion of an electronic pulse when the different types of radiation provide more distinct signals as compared to other portions of the electronic pulse. In a particular embodiment, a Figure of Merit can be used to determine which particular scintillator compounds and corresponding temperature ranges can be used for the dual mode application in conjunction with pulse shape discrimination.

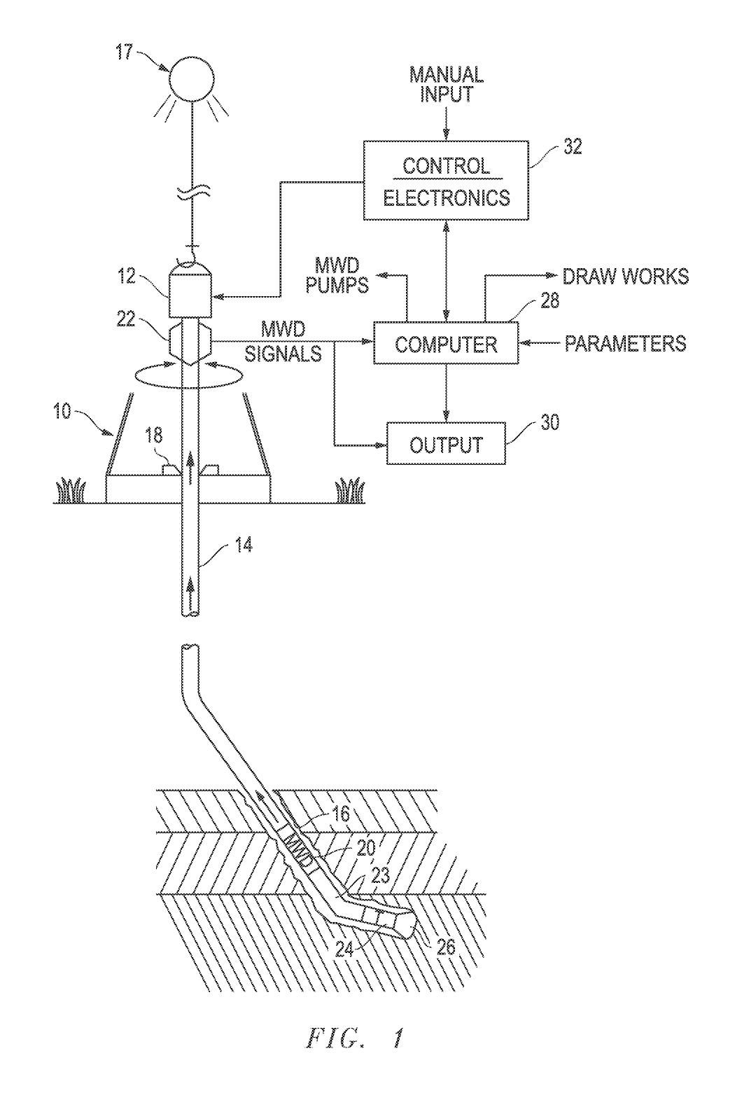

FIG. 1 includes a depiction of a drilling apparatus 10 includes a top drive 12 connected to an upper end of a drill string 14 that is suspended within a well bore 16 by a draw works 17. A rotary table, including pipe slips, 18 can be used to maintain proper drill string orientation in connection with or in place of the top drive 12. A downhole telemetry measurement and transmission device 20, commonly referred to as a measurement-while-drilling (MWD) device, is part of a downhole tool that is connected to a lower end of the drill string 14. The MWD device transmits drilling-associated parameters to the surface by mud pulse or electromagnetic transmission. These signals are received at the surface by a data receiving device 22. The downhole tool includes a bent section 23, a downhole motor 24, and a drill bit 26. The bent section 23 is adjacent the MWD device for assistance in drilling an inclined well bore. The downhole motor 24, such as a positive-displacement-motor (PDM) or downhole turbine, powers the drill bit 26 and is at the distal end of the downhole tool.

The downhole signals received by the data reception device 22 are provided to a computer 28, an output device 30, or both. The computer 28 can be located at the well site or remotely linked to the well site. An analyzer device can be part of the computer 28 or may be located within the downhole tool near the MWD device 20. The computer 28 and analyzer device can include a processor that can receive input from a user. The signals are also sent to an output device 30, which can be a display device, a hard copy log printing device, a gauge, a visual audial alarm, or any combination thereof. The computer 28 is operatively connected to controls of the draw works 17 and to control electronics 32 associated with the top drive 12 and the rotary table 18 to control the rotation of the drill string and drill bit. The computer 28 may also be coupled to a control mechanism associated with the drilling apparatus's mud pumps to control the rotation of the drill bit. The control electronics 32 can also receive manual input, such as a drill operator.

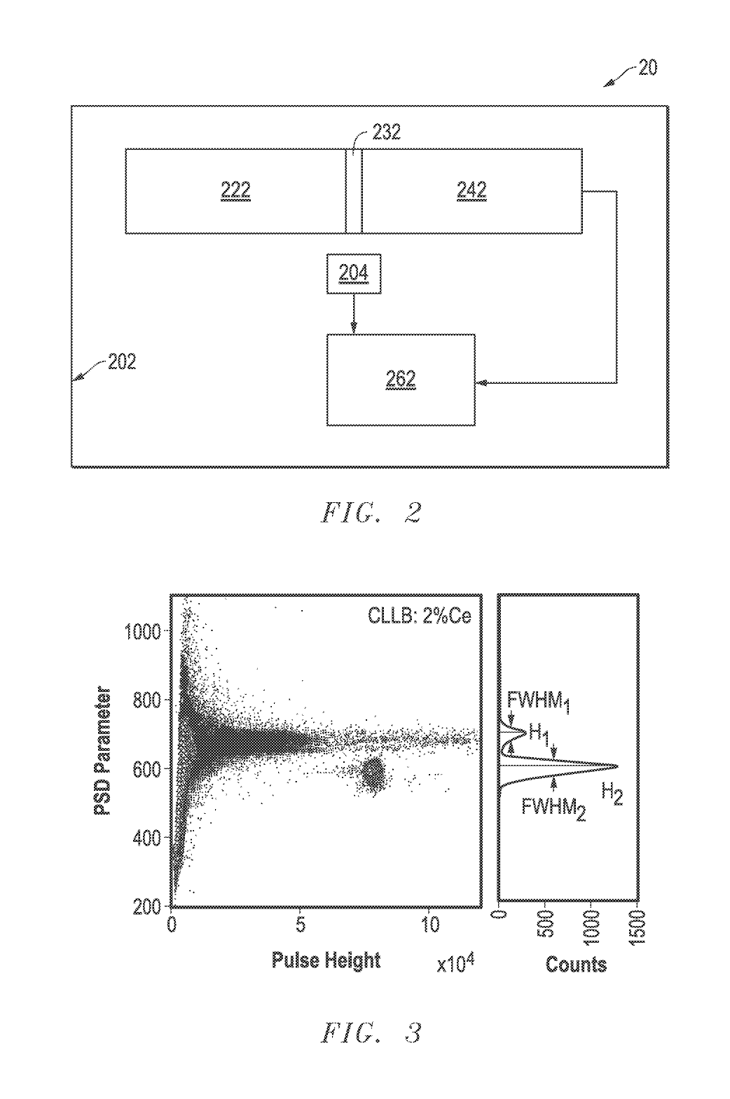

FIG. 2 illustrates a depiction of a portion of the MWD device 20 within the downhole tool 16. The MWD device 20 includes a housing 202, a temperature sensor 204, a scintillator 222, an optical interface 232, a photosensor 242, and an analyzer device 262. The housing 202 can include a material capable of protecting the scintillator 222, the photosensor 242, the analyzer device 262, or a combination thereof, such as a metal, metal alloy, other material, or any combination thereof. The temperature sensor 204 is located adjacent to the scintillator 222, the photosensor 242, or both. The temperature sensor 204 can include a thermocouple, a thermistor, or another suitable device that is capable of determining the temperature within the housing over the normal operating temperature of the MWD device 20. A radiation detection apparatus includes the scintillator 222 that is optically coupled to the photosensor 242 that is coupled to the analyzer device 262.

The scintillator 222 has a composition that is well suited for high temperature applications, such as greater than 120° C., at least 130° C., at least 140° C., at least 150° C., and higher. The scintillator 222 may have a Figure of Merit sufficiently high to allow pulse shape discrimination to be used so that neutrons and gamma radiation can be counted separately. The Figure of Merit is discussed in more detail later in this specification.

In an embodiment, the scintillator includes a rare-earth elpasolite, which has a general formula of:

M₁¹⁺₂M₂⁺¹REX₆,

wherein:

M₁¹⁺ is an element with large size cations belonging to Group 1 elements, in particular Cs, Rb, K and also Na; and

M₂¹⁺ is an element with small and middle size of cations belonging to Group 1 elements, in particular Li or Na.

RE is one or more rare earth elements; and

X is one or more halide elements.

As used herein, the rare earth elements include Sc, Y, La and the lanthanide series of elements.

In a particular embodiment, the scintillator comprises an elpasolite that includes Br, I, or combination thereof. In a more particular embodiment, the scintillator includes both Br and I. In another particular embodiment, Br or I makes up substantially all of the halide content within the elpasolite. Although not fully understood, Cs₂LiYCl₆:Ce (CLYC:Ce) is not as good for pulse shape discrimination between neutrons and gamma radiation at high temperatures, particularly above 120° C., as compared to Br-containing or I-containing elpasolites. Thus, in an embodiment, the scintillator has substantially no Cl. Furthermore, CLYC:Ce has core valance luminescence, and the core valence luminescence may interfere with the ability to discriminate between neutrons and gamma radiation. In another embodiment, the elpasolite has substantially no core valence luminescence generated by Cl.

In a further embodiment, the elpasolite includes at least two different rare earth elements. In a particular embodiment, the elpasolite comprises La, Ce, Pr, or any combination thereof. In still another embodiment, the elpasolite comprises at least two different Group 1 elements. One of the Group 1 elements may be larger than the other Group 1 element. In a particular embodiment, the scintillator comprises Cs, Rb, or any combination thereof, and in another particular embodiment, the scintillator comprises Li, Na, or any combination thereof. In a more particular embodiment, the scintillator can include Li that is enriched with ⁶Li so that ⁶Li makes up more than 7% of the total Li content. In a particular embodiment, ⁶Li makes up at least 70%, at least 80%, or at least 90% of the total Li content. In another embodiment, the scintillator can include Li wherein ⁶Li makes up no greater than 7% of the total Li content. In one embodiment, the elpasolite has a stoichiometric composition, and in another embodiment, the elpasolite has a non-stoichiometric composition.

In a further embodiment, the scintillator is a single crystal. When the scintillator is a single crystal, not all compositions in accordance with a general formula may be possible. For example, a particular composition may be a single crystal when all of the halide content is Br or I or when Br makes up 30% of the total halide content, and I makes up 70% of the total halide content; however when Br makes up 30% of the total halide content, and I makes up 70% of the total halide content, the composition may have separate phases or form at least a partly polycrystalline scintillator. After reading this specification, skilled artisans will appreciate that phase diagrams for the particular compounds may be useful for determining particular starting materials and ratios of such starting materials.

In a particular embodiment, the scintillator has a general formula of:

Cs₍₂₋₂ₓ₋₂ₘ₎Rb₍₂ₓ₎Na₍₂ₘ₎Li_{a(1-y)}Na_{(ay)}La_{b(1-u-v)}Ce_{(bu)}Pr_{(bv)}Br_{(2+a+3b)(1-z)}I_{(2+a+3b)z}

wherein:

each of x, m, y, u, v, and z has a value in a range of 0 to 1; and

each of a and b has a value in a range 0.9 to 1.1.

With respect to the subscripts for a and b; a sum of subscripts for the halide anions can be adjusted to keep electroneutrality. A stoichiometric elpasolite composition corresponds to the above-referenced formula when a=1 and b=1.

In a more particular embodiment, the scintillator has a general formula of:

Cs₂LiLa₍₁₋ᵤ₎Ce₍ᵤ₎Br₆

wherein 0.002≦u≦1.0.

In this particular general formula, the Ce content is sufficiently to improve pulse shape discrimination at high temperatures and still obtain a scintillator that is a single crystal.

In a further particular embodiment, the scintillator has a general formula of:

Cs₂LiLa_{(1-c)}Ce₍ᵤ₎Br₆

wherein 0.01≦u≦0.1.

The Ce content is particular well suited to achieve very good pulse shape discrimination at temperatures higher than 120° C. In each of the preceeding two formulas, Br can be partly or completely replaced by I. While particular formulations have been described, skilled artisans will be capable of using other compositions without departing from the scope of the present invention.

As previously mentioned, Figure of Merit may be used to determine whether a particular scintillator compound may be useful at a particular temperature and still have sufficiently different outputs between neutrons and gamma radiation to allow for pulse shape discrimination. In the description that follows, a particular composition is provided to allow for better understanding of the concepts regarding determining whether a scintillator composition will be good for neutron-gamma pulse shape discrimination.

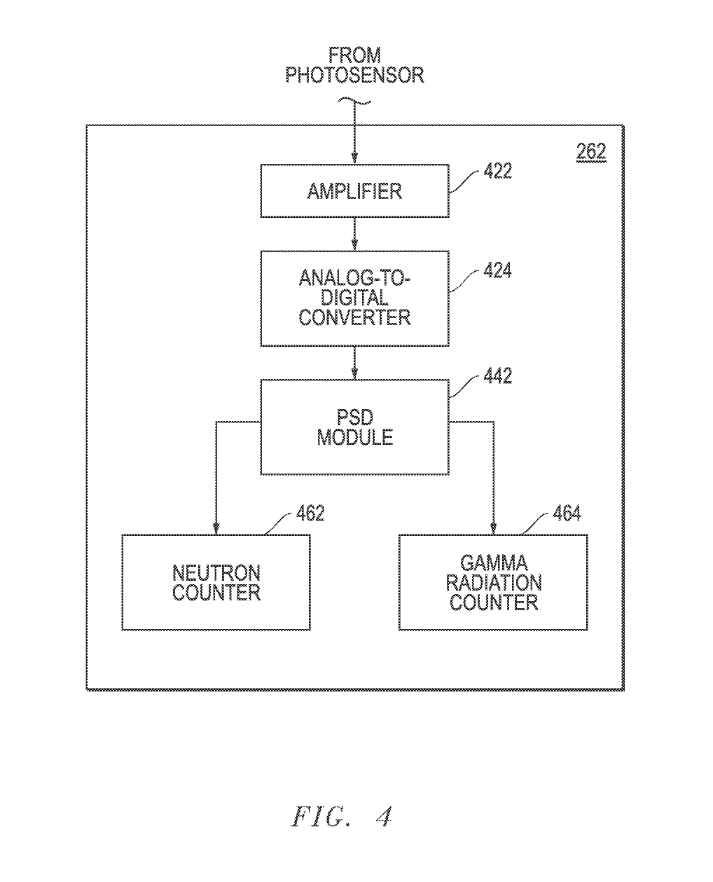

In a particular embodiment, the scintillator with a composition of Cs₂LiLa_{0.98}Ce_{0.02}Br₆ (CLLB:2% Ce) is addressed to aid in understanding how Figure of Merit is determined. The scintillator is exposed to a neutron source, and the electronic pulse received by the analyzer device is processed using a fast Fourier transform to obtain a value for the PSD parameter. The PSD parameter may be determined by the time it takes for the electronic pulse to rise from 2% to 60% of its maximum intensity. Other integration ranges may be used for other scintillating compounds. For example, the PSD parameter may be determined by the time it takes for the electronic pulse to rise from 2% to 50% or 10% to 90% of its maximum intensity. FIG. 3 includes a plot of pulse height versus PSD parameter closer to the left-hand side of FIG. 3. As illustrated in FIG. 3, H₁ corresponds to the peak of the gamma radiation pulses, and H₂ corresponds to the peak of the thermal neutron pulses as illustrated in a plot closer to the right-hand side of FIG. 3. H₁ and H₂ expressed in units of PSD parameter using the Y-axis of the left-hand plot. Thus, H1 is 700 in units of the PSD parameter, and H₂ is 594 in units of the PSD parameter. A full width of half maximum (FWHM) can be obtained from the peaks in the right-hand plot and also be expressed in units of PSD parameter. FWHM₁ corresponds to the FWHM for H₁ and has a value of 37 units of the PSD parameter, and FWHM₂ corresponds to the FWHM for H₂ and has a value of 42 units of the PSD parameter.

As used herein, Figure of Merit (FOM) is defined by the following equation:

|(H₁−H₂)|/(FWHM₁+FWHM₂).

H₁, H₂, FWHM₁, FWHM₂ are all in units of the PSD parameter, and therefore, FOM is dimensionless. For the plot in FIG. 3, FOM is 1.34. Therefore, CLLB:2% Ce has an FOM of 1.34 for the temperature at which the data was collected. Other compositions can be analyzed is a similar manner.

FOM can be determined at different temperatures. When FOM is greater than 0, pulse shape discrimination can be used. As FOM gets larger, pulse shape discrimination is more accurate and the possibility of pulse misclassification is reduced. As FOM approaches 0, pulse shape discrimination is more difficult and the possibility of pulse misclassification is increased. As FOM becomes 0, the pulse shape difference between pulses diminishes, and pulse shape discrimination is substantially impossible. FOM can have a value of at least 0.4 or at least 0.2 to enable accurate pulse shape discrimination. At such a value, a field programmable gate array (FPGA) or application specific integrated circuit (ASIC) can be used for the pulse shape discrimination and be located in the downhole tool 16. Depending on the specific application, a FOM value of 0.2 and potentially lower may be acceptable for pulse shape discrimination.

In an embodiment, the scintillator may have an FOM of at least 0.4 at a temperature greater than 120° C., at least 130° C., at least 140° C., or at least 150° C. In another embodiment, the scintillator may have an FOM of at least 0.05, at least 0.11, at least 0.15, or at least 0.2 at a temperature of 160° C.

In summary, the scintillator can have a FOM to allow for pulse shape discrimination that allows for pulse shape discrimination, the composition may include a Br-containing or an I-containing elpasolite, or both having the FOM and composition.

Returning to FIG. 2, the scintillator 222 and the photosensor 242 are optically coupled to the optical interface 232. The optical interface 232 can include a polymer, such as a silicone rubber, that is used to mitigate the refractive indices difference between the scintillator 222 and the photosensor 242. In other embodiments, the optical interface 232 can include gels or colloids that include polymers and additional elements.

The photosensor 242 can be a photomultiplier tube (PMT), a silicon photomultiplier (SiPM), a hybrid photosensor, or any combination thereof. The photosensor 242 can receive photons emitted by the scintillator 222 and produce electronic pulses based on numbers of photons that it receives. The photosensor 242 is electrically coupled to the analyzer device 262. Although not illustrated in FIG. 2, an amplifier may be used to amplify the electronic signal from the photosensor 242 before it reaches the analyzer device 262.

The analyzer device 262 can include hardware and can be at least partly implemented in software, firmware, or a combination thereof. In an embodiment, the hardware can include a plurality of circuits within an FPGA, an ASIC, another integrated circuit or on a printed circuit board, or another suitable device, or any combination thereof. The analyzer device 262 can also include a buffer to temporarily store data before the data are analyzed, written to storage, read, transmitted to another component or device, another suitable action is performed on the data, or any combination thereof. In the embodiment illustrated in FIG. 4, the analyzer device 262 can include an amplifier 422 coupled to the photosensor 242, such that an electronic pulse from the photosensor 242 can be amplified before analysis. The amplifier 222 can be coupled to an analog-to-digital converter (ADC) 424 that can digitize the electronic pulse. The ADC 424 can be coupled to a pulse shape discrimination (PSD) module 442. In a particular embodiment, the PSD module 442 can include a FPGA or an ASIC. In a particular embodiment, the PSD module 442 can include circuits to analyze the shape of the electronic pulse and determine whether the electronic pulse corresponds to a neutron or gamma radiation. In a more particular embodiment, the PSD module 442 can use the electronic pulse and temperature from the temperature sensor 204 with a look-up table to determine whether the electronic pulse corresponds to a neutron or gamma radiation. The look-up table can be part of the FPGA or ASIC or may be in another device, such as an integrated circuit, a disk drive, or a suitable persistent memory device.

The analyzer device 262 further comprises a neutron counter 462 and a gamma radiation counter 464. If the PSD module 442 determines that an electronic pulse corresponds to a neutron, the PSD module 442 increments the neutron counter 462. If the PSD module 442 determines that an electronic pulse corresponds to gamma radiation, the PSD module 442 increments the gamma radiation counter 464.

In an alternative embodiment, part or all of the components and functions provided by the analyzer device 262 can be located outside the well bore, either at the well drilling site or remote to the well drilling site, such as in an office building.

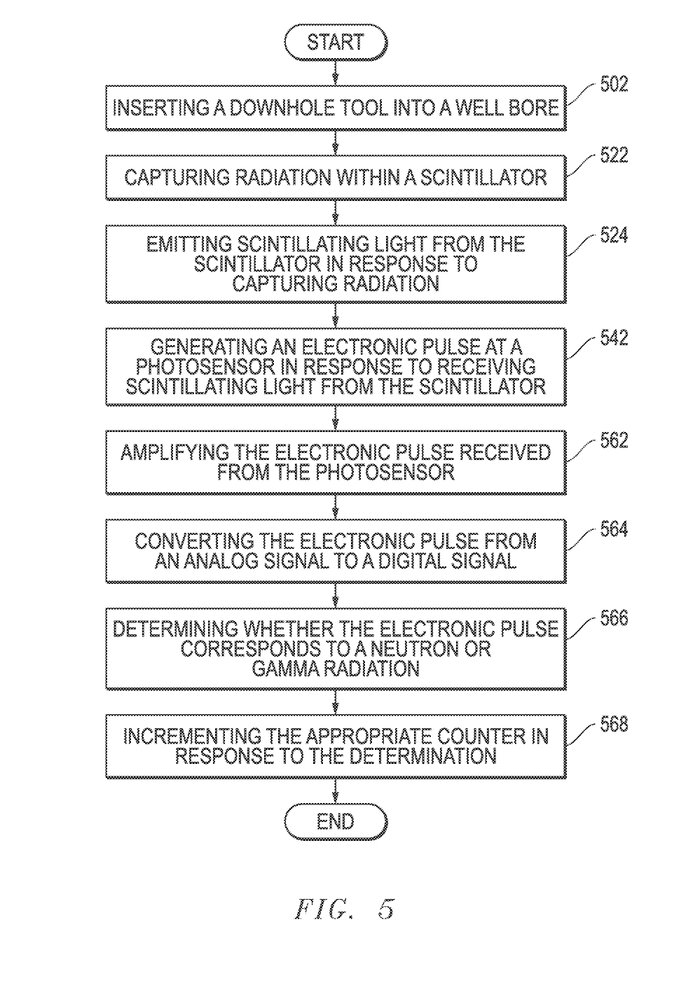

FIG. 5 includes a flowchart of an exemplary method of using the drilling apparatus as illustrated in FIG. 1 including the MWD device 20. The method will be described with respect to components within the drilling apparatus as illustrated in FIG. 1, the MWD device 262 as illustrated in FIG. 2, and the analyzer device as illustrated in FIG. 4. After reading this specification, skilled artisans will appreciate that activities described with respect to particular components may be performed by another component. Further, activities described with respect to particular components may be combined into a single component, and activities described with respect to a single component may be distributed between different components.

The method can begin with inserting the downhole tool into the well bore 16, at block 502 in FIG. 5. Referring to FIG. 1, the drill bit 26 can be activated by pumping mud down the drill string 14 to turn the downhole motor 24. For directional drilling, the orientation of the drill bit can be controlled using the top drive 12. When the direction of drilling is to continue along a straight line, the top drive 12 rotates drill string 14 while downforce pressure is exerted by the draw works 17. To change direction, the top drive 12 is used to position the tool face of the downhole tool. The downforce pressure may be reduced when the direction is being changed. After the toolface is in the correct position, the top drive 12 no longer rotates the drill string, as the bent section 23 causes the direction of drilling to change. The downforce pressure is increased on the bit 26 and drilling continues as the direction changes. After the proper direction is achieved, the top drive 12 is activated to rotate the drill string 14 so that further drilling continues in the new direction. During drilling significant heat can be generated, and the resulting temperature can be greater than 120° C., at least 130° C., at least 140° C., at least 150° C., or even higher. Also during, drilling data is collected by the MWD device 20. The scintillator 222 is selected so that at such temperatures, the scintillator 222 can generate different scintillating light corresponding to different types of radiation that is converted by the photosensor 242 into different types of electronic pulses depending on the type of radiation captured.

The method can include capturing radiation and emitting scintillating light, at blocks 522 and 524 in FIG. 5. The radiation can be captured by the scintillator 222, and the scintillating light can be emitted by the scintillator 222 in response to capturing the radiation. The method can further include generating an electronic pulse at the photosensor 242 in response to receiving scintillating light from the scintillator 222, at block 542. The electronic pulse can be provided by the photosensor 242 to the analyzer device 262. The method can further include amplifying the electronic pulse, at block 562. The electronic signal may be amplified by a pre-amplifier or an amplifier within the photosensor 242 or the analyzer device 262. The method can also include converting the electronic pulse from an analog signal to a digital signal, at block 564.

The method can include determining whether electronic pulse corresponds to a neutron or gamma radiation, at block 566 in FIG. 5. In an embodiment, determination can be performed by an FPGA, an ASIC, or another suitable device. Analysis of the pulse can include determining a rise time of the pulse, a decay time, another suitable parameter that can be useful in making the determination, or any combination thereof. The determination can be performed using the PSD module 442. The PSD module 442 may use temperature information from the temperature sensor 204 as part of the determination. The method can further include incrementing the appropriate counter in response to the determination, at block 568. When the electronic pulse is determined to correspond to a neutron, the neutron counter 462 is incremented. When the electronic pulse is determined to correspond to gamma radiation, the gamma radiation counter 464 is incremented.

Referring to FIG. 5, some of the actions described with respect to blocks 562, 564, 566, and 568 can be performed by the analyzer device 262. All of the analyzer device 262 may be within the MWD device 20 or may be outside the well bore 16. In another embodiment, the amplifier 422 and ADC 424 may be within the MWD device 20, and the PSD module 442 and counters 462 and 464 may be located at the surface outside the well bore 16. After reading this specification, skilled artisans will be able to determine where the analyzer device or components of the analyzer device 262 are to be located in view of the FOM of the scintillator for the normal operating temperatures, computational needs that may or may not depend on the FOM or composition of the scintillator, and the particular application.

While the radiation detection apparatus is described with respect to a drilling apparatus, the radiation detection apparatus can be part of a well logging apparatus that does not perform a drilling operation. Similar to the downhole tool with the drill bit 26, the well logging apparatus can include a downhole tool without the drill bit. A flexible string may be coupled to the downhole tool to allow the downhole tool to lowered and raised within the well bore 16. If needed or desired a drill string may be coupled to the downhole tool.

The concepts as described herein allow for a better selection of a scintillator that has an acceptable FOM over the normal operating temperatures for an apparatus. The acceptable FOM allows the pulse shape discrimination to be used that will discriminate two different types of radiation and allow pulse shape discrimination to be tailored to a particular portion of an electronic pulse where differences between the different types of radiation are more distinct as compared to other portions of the electronic pulse. Thus, FOM can be used for selecting a composition for the scintillator and selecting the particular portion of electronic pulses where distinctions between the different types of radiation are greater than other portions. The concepts described herein can be extended to other types of radiation, such as x-rays, alpha particles, beta particles, etc. and are not limited to neutrons and gamma radiation.

Many different aspects and embodiments are possible. Some of those aspects and embodiments are described herein. After reading this specification, skilled artisans will appreciate that those aspects and embodiments are only illustrative and do not limit the scope of the present invention. Additionally, those skilled in the art will understand that some embodiments that include analog circuits can be similarly implement using digital circuits, and vice versa. Embodiments may be in accordance with any one or more of the items as listed below.

Item 1. A scintillator having a Figure of Merit of at least 0.4 at a first temperature greater than 120° C., at least 0.05 at 160° C., or both.

Item 2. A radiation detection apparatus including a scintillator having a Figure of Merit of at least 0.4 at a first temperature greater than 120° C., at least 0.05 at 160° C., or both; a photosensor optically coupled to the scintillator; and an analyzer device having coupled to the photosensor, wherein the analyzer device is capable of distinguishing a first pulse from the photosensor from a second pulse from the photosensor, wherein the first pulse corresponds to a neutron as captured by the scintillator when the scintillator is at a second temperature greater than 120° C., and a second pulse corresponds to gamma radiation as captured by the scintillator when the scintillator is at a third temperature greater than 120° C.

Item 3. The radiation detection apparatus of Item 2, wherein the analyzer device further includes a discrimination module that is configured to discriminate between the neutron and the gamma radiation using rise time, decay time, or a combination thereof.

Item 4. The radiation detection apparatus of Item 2 or 3, wherein the second temperature and the third temperature are within 5° C., 3° C., or 0.9° C., of each other.

Item 5. An apparatus including a downhole tool configured to be inserted into a well bore and including a scintillator having a Figure of Merit of at least 0.4 at a temperature greater than 120° C., at least 0.05 at a temperature at 160° C., or both; and a photosensor optically coupled to the scintillator.

Item 6. The apparatus of Item 5, further including an analyzer device having coupled to the photosensor, wherein the analyzer device is part of the downhole tool.

Item 7. The apparatus of Item 5, further including an analyzer device having coupled to the photosensor, wherein the analyzer device is configured to be operated outside of the well bore and spaced apart from the downhole tool.

Item 8. The apparatus of any one of Items 5 to 7, further including a string coupled to the downhole tool.

Item 9. A method of using a radiation detection apparatus including emitting scintillating light from a scintillator at a temperature greater than 120° C.; generating an electronic pulse corresponding to the scintillating light; and determining whether the electronic pulse corresponds to a neutron or gamma radiation.

Item 10. The method of Item 9, wherein generating is performed using a photosensor, and determining is performed using an analyzer device.

Item 11. The method of Item 9 or 10, further including inserting the scintillator into a well bore.

Item 12. The method of any one of Items 8 to 10, wherein the scintillator is within a housing, and an internal temperature within the housing is at least 130° C., at least 140° C., or at least 150° C.

Item 13. The radiation detection apparatus or the method of any one of Items 2 to 8 and 10 to 12, wherein the analyzer device includes a pulse shape discrimination module that is configured to discriminate between the neutron and the gamma radiation using rise time, decay time, or a combination thereof.

Item 14. The scintillator, the radiation detection apparatus, or the method of any one of the preceding Items, wherein as compared to gamma radiation, the neutron has a faster rise time, a faster decay time, or both.

Item 15. The scintillator, the radiation detection apparatus, or the method of any one of the preceding Items, wherein the scintillator has a Figure of Merit of 0.4 at a temperature of at least 130° C., at least 140° C., or at least 150° C.

Item 16. The scintillator, the radiation detection apparatus, or the method of any of the preceding Items, wherein the scintillator has a Figure of Merit of at least 0.11, at least 0.15, or at least 0.2 at a temperature of at 160° C.

Item 17. The scintillator, the radiation detection apparatus, or the method of any one of the preceding Items, wherein the scintillator includes an elpasolite that includes Br, I, or combination thereof.

Item 18. The scintillator, the radiation detection apparatus, or the method of Item 17, wherein the scintillator includes both Br and I.

Item 19. The scintillator, the radiation detection apparatus, or the method of Item 17, wherein Br or I makes up substantially all of the halide content within the elpasolite.

Item 20. The scintillator, the radiation detection apparatus, or the method of any one of Items 17 to 19, wherein the scintillator has substantially no Cl.

Item 21. The scintillator, the radiation detection apparatus, or the method of any one of Items 17 to 20, wherein the elpasolite has substantially no core valence luminescence.

Item 22. The scintillator, the radiation detection apparatus, or the method of any one of Items 17 to 21, wherein the elpasolite includes at least two different rare earth elements.

Item 23. The scintillator, the radiation detection apparatus, or the method of any one of Items 17 to 22, wherein the elpasolite includes La, Ce, Pr, or any combination thereof.

Item 24. The scintillator, the radiation detection apparatus, or the method of any one of Items 17 to 23, wherein the elpasolite includes at least two different Group 1 elements.

Item 25. The scintillator, the radiation detection apparatus, or the method of any one of Items 17 to 24, wherein the scintillator includes Cs, Rb, K, or any combination thereof.

Item 26. The scintillator, the radiation detection apparatus, or the method of any one of Items 17 to 25, wherein the scintillator includes Li, Na, or any combination thereof.

Item 27. The scintillator, the radiation detection apparatus, or the method of any one of Items 17 to 26, wherein the elpasolite has a stoichiometric composition.

Item 28. The scintillator, the radiation detection apparatus, or the method of any one of Items 17 to 26, wherein the elpasolite has a non-stoichiometric composition.

Item 29. The scintillator, the radiation detection apparatus, or the method of any one of Items 17 to 28, wherein the scintillator has a general formula of:

Cs₍₂₋₂ₓ₋₂ₘ₎Rb₍₂ₓ₎Na₍₂ₘ₎Liₐ₍₁₋₇₎Na_{(ay)}La_{b(1-u-v)}Ce_{(bu)}Pr_{(bv)}Br_{(2+a+3b)(1-z)}I_{(2+a+3b)z}, wherein:

each of x, m, y, u, v, and z has a value in a range of 0 to 1;

0.9<a<1.1; and

0.9<b<1.1.

Item 30. The scintillator, the radiation detection apparatus, or the method of any one of Items 17 to 29, wherein the scintillator has a general formula of:

Cs₂LiLa₍₁₋ᵤ₎Ce₍ᵤ₎Br₆

wherein 0.002≦u≦1.0.

Item 31. The scintillator, the radiation detection apparatus, or the method of any one of Items 17 to 30, wherein the scintillator has a general formula of:

Cs₂LiLa_{(1-c)}Ce₍ᵤ₎Br₆

wherein 0.01≦u≦0.1.

Item 32. The scintillator, the radiation detection apparatus, or the method of any one of Items 17 to 29, wherein the scintillator has a general formula of:

Cs₂LiLa₍₁₋ᵤ₎Ce₍ᵤ₎I₆

wherein 0.002≦u≦1.0

Item 33. The scintillator, the radiation detection apparatus, or the method of any one of Items 17 to 29, wherein the scintillator has a general formula of:

Cs₂LiLa₍₁₋ᵤ₎Ce₍ᵤ₎I₆

wherein 0.002≦u≦0.1

Item 34. The scintillator, the radiation detection apparatus, or the method of any one of the preceding claims, wherein the scintillator is a single crystal.

### Example

The Example is given by way of illustration only and do not limit the scope of the present invention as defined in the appended claims. The Example demonstrates the selection of composition of a scintillator and determining what portion of an electronic pulse would work well for pulse shape discrimination.

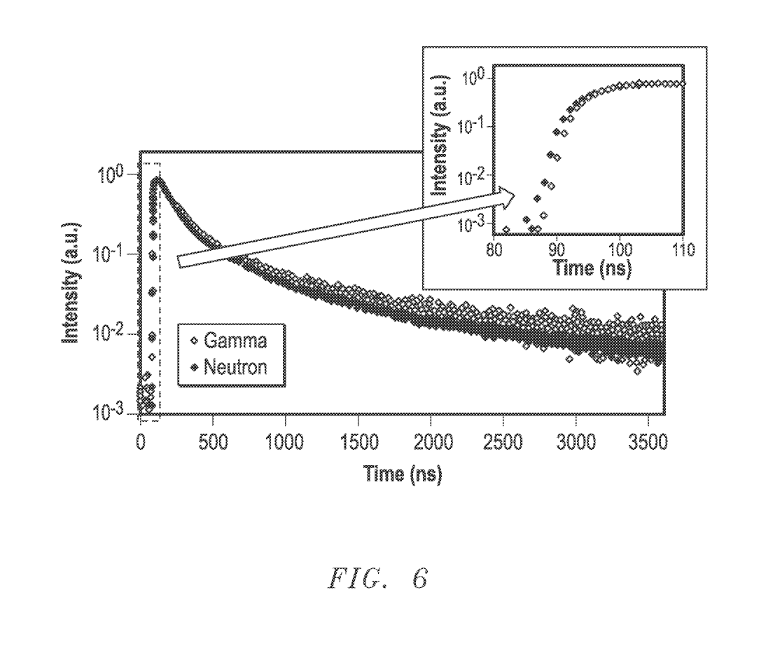

Data was collected on a variety of scintillator compounds. The scintillator compounds included Cs₂LiLa_{0.995}Ce_{0.005}Br₆ (CLLB:0.5% Ce), CLLB:2% Ce, and Cs₂LiLa_{0.965}Ce_{0.035}Br₆ (CLLB:3.5% Ce). The scintillators were exposed to ²⁵²Cf having a mass of approximately 109 nanogram and placed about 30 cm from the scintillator. The exposure was performed over a variety of temperatures from about −40° C. to 160° C. Radiation captured by the scintillators caused scintillating light to be emitted that was collected by a photosensor, which in turn generated an electronic pulse. FIG. 6 includes a plot of time versus intensity for CLLB:2% Ce. As can be seen from the plot, neutrons have a faster rise time and decay time. A portion of the rise time is enlarged in FIG. 6 to illustrate that the difference in rise times for neutrons and gamma radiation are more distinct as compared to other parts of the plots. Similar plots can be generated for CLLB:0.5% Ce and CLLB:3.5% Ce but are not illustrated.

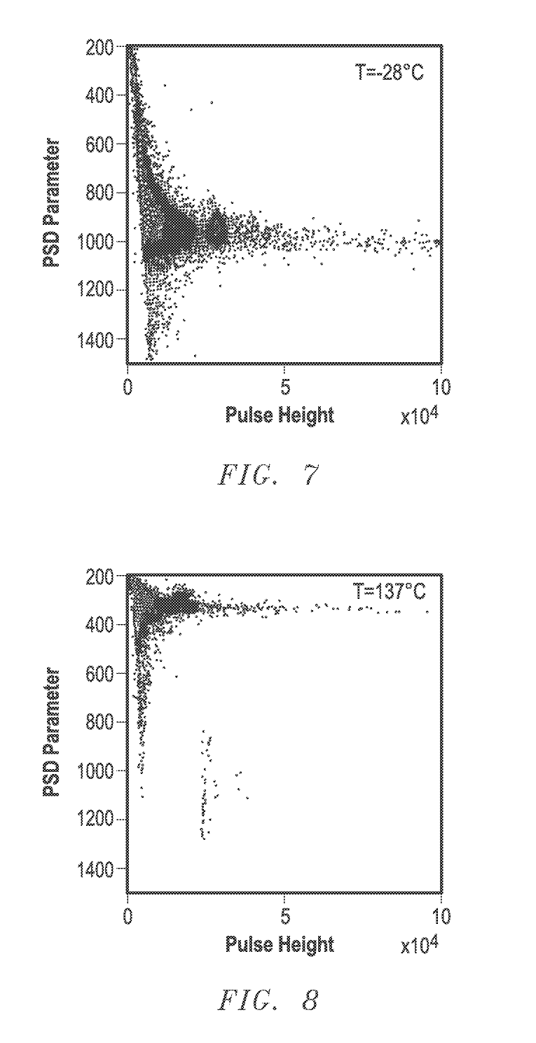

A fast Fourier transform (FFT) can be performed on a portion of the pulses where the distinction between the different types of radiation is believed to be the greatest. For CLLB:2% Ce, FFT was performed on the electronic pulse when the scintillator was at a temperature of 25° C. The plots as illustrated in FIG. 3 were generated using the 2-60 rise time data. FOM was calculated to be 1.34 for the 2-60 rise time data and 1.00 for the 10-90 rise time data. Thus, both sets of PSD data yield a sufficiently high FOM and can be used. Between the two, the algorithm using the time for the pulse to rise from 2% to 60% of its maximum intensity has better pulse shape discrimination. FOM was also calculated for the other two compositions based on the time for the pulse to rise from 2% to 60% of its maximum intensity. For CLLB:0.5% Ce, FOM was 1.02 and for CLLB:3.5% Ce, FOM was estimated to be 0.5. FIGS. 7 and 8 include plots for pulse height versus PSD parameter for CLLB:2% Ce at temperatures of −28° C. and 137° C. for the same time period as the left-hand plot in FIG. 3.

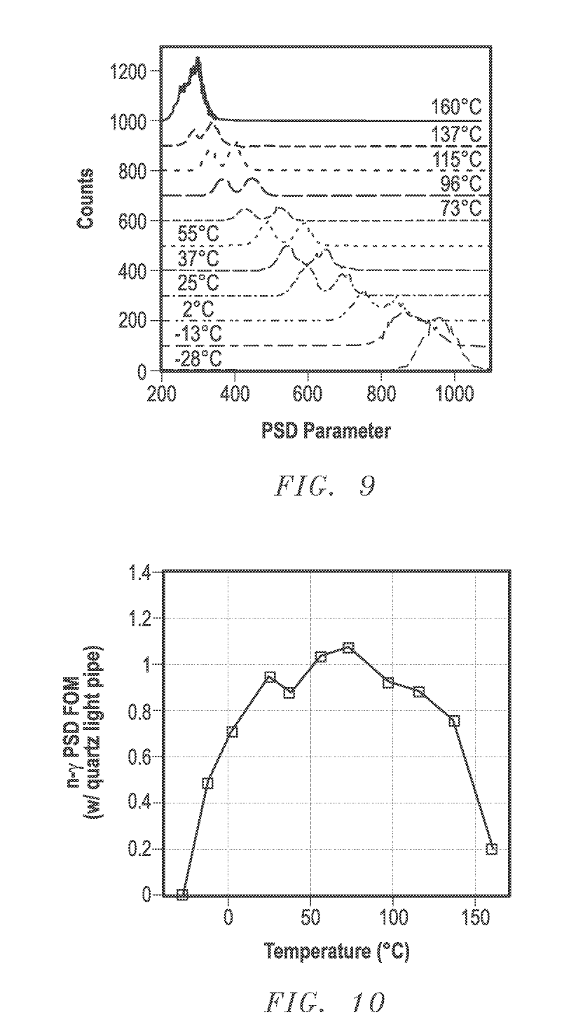

FIG. 9 includes PSD spectra versus counts at a variety of temperatures when using CLLB:2% Ce and with the 2-60% rise time data. At temperatures of 2° C. to 137° C., two distinct peaks can clearly be seen. At lower and higher temperatures, the peaks start to get closer to each other, and thus, pulse shape discrimination becomes more difficult and need more complex computations to determine whether an electronic pulse corresponds to a neutron or a gamma ray.

FIG. 10 includes a corresponding plot of temperature versus FOM based on the data used to generate FIG. 9. When FOM is greater than 0, the neutrons and gamma radiation can be distinguished from each other. As can be seen in FIG. 10, FOM is nearly 0 at −28° C., and thus, CLLB:2% Ce may not be a good dual-mode scintillator at a temperature of −28° C. FOM generally increased to a temperature of 73° C. and generally decreases to about 0.2 at 160° C. FOM may not reach 0 again until the temperature reaches 170° C. to 180° C. FOM is 0.5 at about −15° C. and about 150° C. When FOM is 0.4, discrimination can be readily implemented using an FPGA or ASIC and also allow a sufficient confidence level that results is an acceptably low risk that radiation will be misclassified. Therefore, CLLB:2% Ce can be used as a dual mode scintillator for neutrons and gamma radiation over a temperature from −15° C. to 150° C. and can be used outside that temperature range if needed or desired.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Certain features, that are for clarity, described herein in the context of separate embodiments, may also be provided in combination in a single embodiment. Conversely, various features that are, for brevity, described in the context of a single embodiment, may also be provided separately or in a subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A scintillator having a Figure of Merit of at least 0.4 at a first temperature greater than 120° C., at least 0.05 at 160° C., or both.

2. An apparatus including a downhole tool configured to be inserted into a well bore and comprising:
the scintillator of claim 1; and
a photosensor optically coupled to the scintillator.

3. A radiation detection apparatus comprising:
a scintillator having a Figure of Merit of at least 0.4 at a first temperature greater than 120° C., at least 0.05 at 160° C., or both;
a photosensor optically coupled to the scintillator; and
an analyzer device having coupled to the photosensor, wherein the analyzer device is capable of distinguishing a first pulse from the photosensor from a second pulse from the photosensor, wherein the first pulse corresponds to a neutron as captured by the scintillator when the scintillator is at a second temperature greater than 120° C., and a second pulse corresponds to gamma radiation as captured by the scintillator when the scintillator is at a third temperature greater than 120° C.

4. The radiation detection apparatus of claim 3, wherein the analyzer device includes a pulse shape discrimination module that is configured to discriminate between the neutron and the gamma radiation using rise time, decay time, or a combination thereof.

5. The radiation detection apparatus of claim 3, wherein as compared to gamma radiation, the neutron has a faster rise time, a faster decay time, or both.

6. The radiation detection apparatus of claim 3, wherein the scintillator has a Figure of Merit of 0.4 at a temperature of at least 130° C., at least 140° C., or at least 150° C.

7. The radiation detection apparatus of claim 3, wherein the scintillator has a Figure of Merit of at least 0.11, at least 0.15, or at least 0.2 at a temperature of at 160° C.

8. The radiation detection apparatus of claim 3, wherein the scintillator comprises an elpasolite that includes Br, I, or combination thereof.

9. The radiation detection apparatus of claim 8, wherein Br or I makes up substantially all of the halide content within the elpasolite.

10. The radiation detection apparatus of claim 8, wherein the scintillator has substantially no Cl.

11. The radiation detection apparatus of claim 8, wherein the elpasolite has substantially no core valence luminescence.

12. The radiation detection apparatus of claim 8, wherein the elpasolite comprises at least two different rare earth elements.

13. The radiation detection apparatus of claim 8, wherein the elpasolite comprises at least two different Group 1 elements.

14. The radiation detection apparatus of claim 8, wherein the scintillator comprises Li, Na, or any combination thereof.

15. The radiation detection apparatus of claim 8, wherein the elpasolite has a stoichiometric composition.

16. The radiation detection apparatus of claim 8, wherein the elpasolite has a non-stoichiometric composition.

17. The radiation detection apparatus of claim 8, wherein the scintillator has a general formula of:
Cs₍₂₋₂ₓ₋₂ₘ₎Rb₍₂ₓ₎Na₍₂ₘ₎Li_{a(1-y)}Na_{(ay)}La_{b(1-u-v)}Ce_{(bu)}Pr_{(bv)}Br_{(2+a+3b)(1-z)}I_{(2+a+3b)z}
wherein:
each of x, m, y, u, v, and z has a value in a range of 0 to 1;
0.9<a<1.1; and
0.9<b<1.1.

18. A method of using a radiation detection apparatus comprising:
emitting scintillating light from a scintillator at a temperature greater than 120° C.;
generating an electronic pulse corresponding to the scintillating light; and
determining whether the electronic pulse corresponds to a neutron or gamma radiation.

19. The method of claim 18, further comprising inserting the scintillator into a well bore.

20. The method of claim 18, wherein the scintillator is within a housing, and an internal temperature within the housing is at least 130° C., at least 140° C., or at least 150° C.
